(19) United States
(12) Patent Application Publication
(10) Pub. No.: US 2022/0341180 A1
(43) Pub. Date: Oct. 27, 2022

(54) BUCKET HOLDER

(71) Applicant: Tom Holtschult, ROHNERT PARK, CA (US)

(72) Inventor: Tom Holtschult, ROHNERT PARK, CA (US)

(21) Appl. No.: 17/240,756

(22) Filed: Apr. 26, 2021

(51) Int. Cl. E04D 15/00; B44D 3/14

(52) U.S. Cl. CPC E04D 15/00; B44D 3/14

(57) ABSTRACT

A bucket holder is presented for securing a bucket upon a sloped surface, such as a roof. The bucket holder comprises a base member and at least two legs extended outward and below the primary plane of base member to retain the base member stable upon the sloped surface. Next, at least two retaining arms at least one locking arm having a tab extended outward and above the base member. The at least one locking arm is adjoined to the base member. In exemplary operation, the bucket holder is place upon the sloped surface and the attachment member adjoins to the sloped surface. Next, the bucket is placed upon the base member and secured by the at least one locking arm or tab over a top surface of the bucket.

### BACKGROUND

### 1. Field of the Invention

The present invention relates to a bucket holder for securing a position of a bucket to a sloped surface.

### 2. Description of Related Art

During common work practices such as construction, cleaning, repair, or maintenance tasks, it is common for a human to have to work on or stand upon a sloped surface, such as a roof. Problems arise when liquids or paints need to be held in a secured and stable position upon the sloped surfaces during such work practices. Injury, death, and poor work practices can occur from slipping when liquids or paints are spilled upon sloped surfaces decreasing the friction coefficient of the surface. A better solution is needed for safely securing an article or a bucket on a sloped surface.

### SUMMARY

The present invention relates to a bucket holder for securing a bucket upon a sloped surface. The bucket upon the bucket holder is secured in a fixed position and held stable upon the base member to prevent spilling any liquid or paint that may be within the bucket. Further, the present invention provides attachment members to lock and temporarily adjoin the bucket holder to the sloped surface. For example, upon a metal roof, the present invention provides a magnet in a leg to adjoin the leg to the metal roof.

Another object of the present invention is to provide a bucket holder configurable for different sizes of buckets placed upon the bucket holder. For example, the bucket holder may include telescoping members or spring-loaded members to adjust to the size and shape of the bucket or article held upon the bucket holder.

In order to do so, a bucket holder is presented for securing a bucket upon a sloped surface, such as a roof. The bucket holder comprises a base member and at least two legs extended outward and below the base member to retain the base member stable upon the sloped surface. Next, at least two retaining arms and at least one locking arm extend outward and above the base member. The at least one locking arm is adjoined to the base member. In exemplary operation, the bucket holder is placed upon the sloped surface and the attachment member adjoins to the sloped surface. Next, the bucket is placed upon the base member and secured by the at least one locking arm or tab over a top surface of the bucket.

### BRIEF DESCRIPTION OF THE FIGURES

The detailed description of some embodiments of the invention is made below with reference to the accompanying figures, wherein like numerals represent corresponding parts of the figures.

The novel features of the disclosure are set forth with particularity in the appended claims. A better understanding of the features and advantages of the present disclosure will be obtained by reference to the following detailed description that sets forth illustrative embodiments, in which the principles of the disclosure are utilized, and the accompanying drawings of which:

FIG. 1 shows an exemplary isometric view of one embodiment of the bucket holder.

FIG. 2 shows an exemplary isometric view of one embodiment of the bucket holder.

FIG. 3 shows an exemplary isometric view of one embodiment of the bucket holder upon an exemplary roof.

FIG. 4A shows an exemplary isometric view of one embodiment of the bucket holder upon an exemplary roof.

FIG. 4B shows an exemplary detail view of one embodiment of the bucket holder as shown in FIG. 4A.

FIG. 5 shows an exemplary side view of one embodiment of the bucket holder.

FIG. 6 shows an exemplary rear view of one embodiment of the bucket holder. FIG. 1 shows an exemplary isometric view of one embodiment of the bucket holder.

FIG. 7 shows an exemplary isometric view of one embodiment of the bucket holder.

FIG. 8 shows an exemplary isometric view of one embodiment of the bucket holder.

FIG. 9 shows an exemplary bottom view of one embodiment of the bucket holder.

### DETAILED DESCRIPTION OF CERTAIN EMBODIMENTS

While preferred embodiments of the present disclosure have been shown and described herein, it will be obvious to those skilled in the art that such embodiments are provided by way of example only. Numerous variations, changes, and substitutions will now occur to those skilled in the art without departing from the disclosure. It should be understood that various alternatives to the embodiments of the disclosure described herein may be employed in practicing the disclosure.

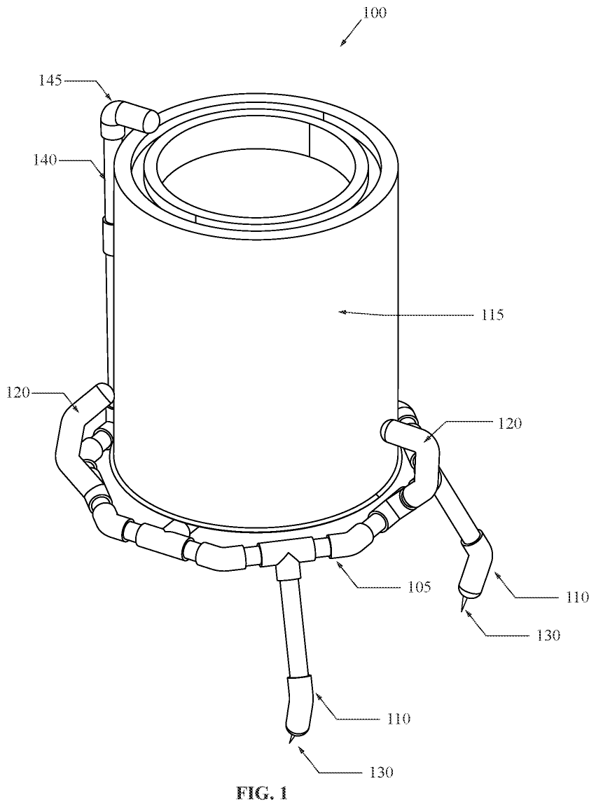

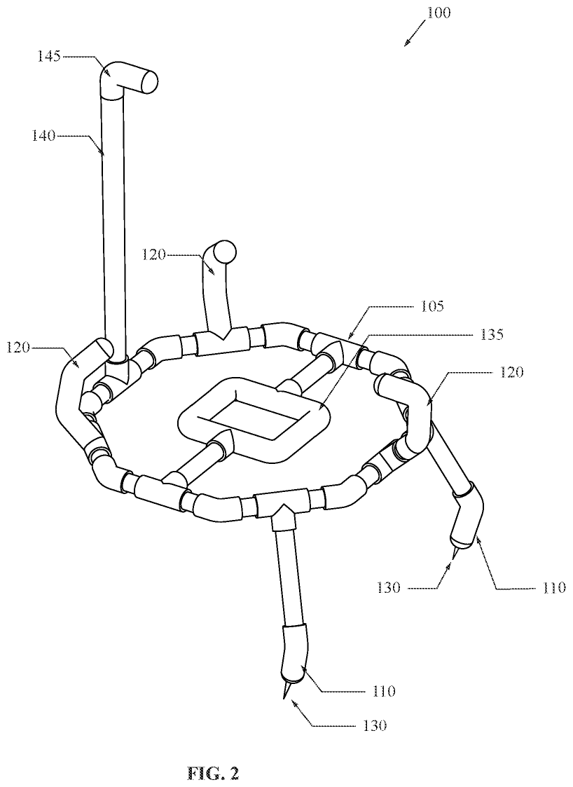

As shown in FIGS. 1 and 2, a bucket holder 100 for securing a bucket 115 upon a sloped surface is shown. The bucket holder 100 includes a base member 105 having a primary plane parallel to the base member. In some embodiments, the base member 105 further comprises a platform. Next, at least two legs 110 extended outward and below the primary plane of base member 105. The at least two legs 110 having a proximal end and a distal end, wherein the proximal end adjoins to the base member 105. Above the base member 105, at least two retaining arms 120 extend outward and above the primary plane of base member 105. Similarly, at least one locking arm 140 having a tab 145 and extends outward perpendicular above the primary plane of base member 105. In some embodiments, the at least one locking arm 140 is rotatably adjoined to the base member 105. Upon the at least two legs 110 an attachment member 130 is adjoined to the distal end to come in contact with the slope surface when the bucket holder 100 is placed upon the sloped surface. During exemplary operation, the bucket is placed upon the base member 105 and secured by rotation of the at least one locking arm 140 or the tab 145. As shown in FIG. 2, in various embodiments a support member 135 is positioned within the base member to reinforce the base member 105. The support member may include a metal member or a member shaped to a shape known to one skilled in the art for static load reinforcement.

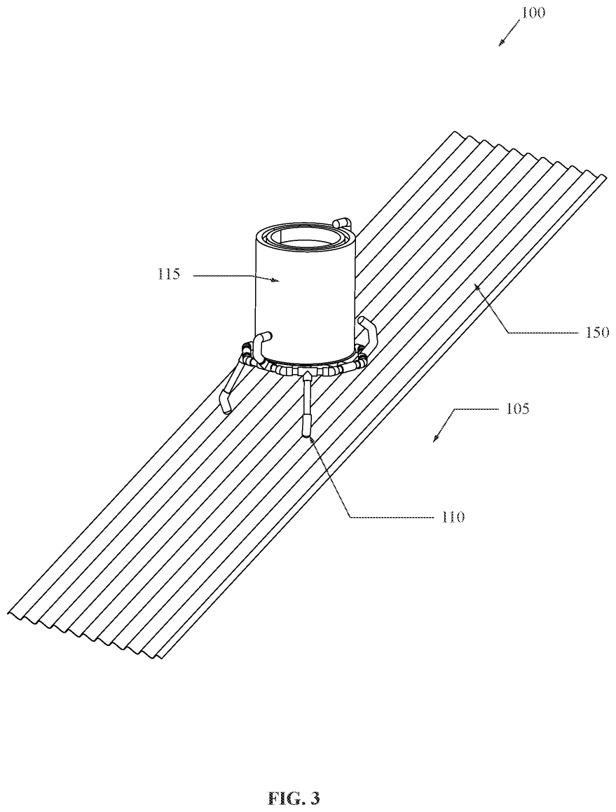

As shown in FIG. 3, the bucket holder 100 may be specifically adapted for use with a metal material 150 or roof. In some embodiments, the attachment member 130 may be configurable by the user for use with the metal material 150 or roof. For example, in a workplace having a corrugated metal roof the attachment member 130 of the at least two legs 110 may comprise a magnet.

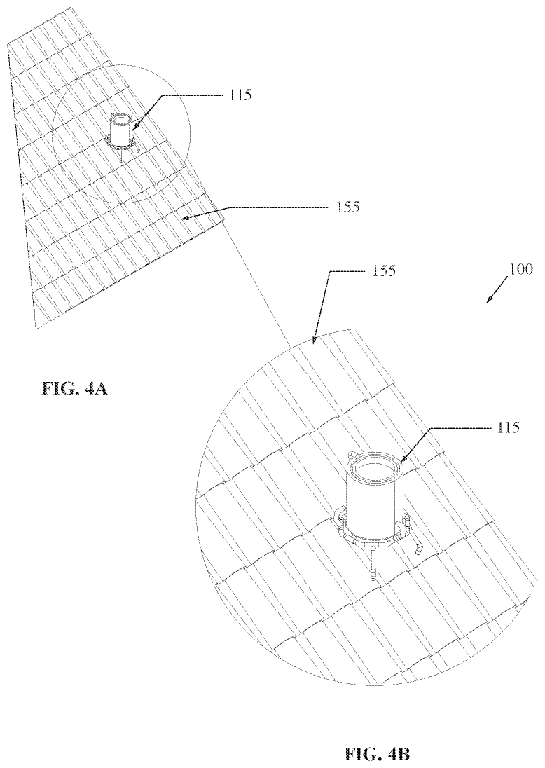

As shown in FIG. 4A and FIG. 4B, the bucket holder 100 may be specifically adapted for use with a roof 155. In some embodiments, the attachment member 130 may be configurable by the user for use with commonly available roof types. For example, in a workplace having a shingled roof the attachment member 130 of the at least two legs 110 may comprise a member to fit between the shingles of the roof. Exemplary roof types adapted for use with the bucket holder 100 include, without limitation, asphalt shingles, ceramic roofing tiles, slate roof shingles, wood shakes, and cedar shingles, and metal roofing types. In some embodiments, the bucket holder 100 is configured to match commercially available roof slopes of different structures such as, without limitation, roof slopes between 2/12 pitch to a 9/12 pitch. The bucket holder 100 may be configured by the user to hold the bucket or article upon the base member 105 of the bucket holder 100 level to the roof or leaning inward towards or outward away from the roof.

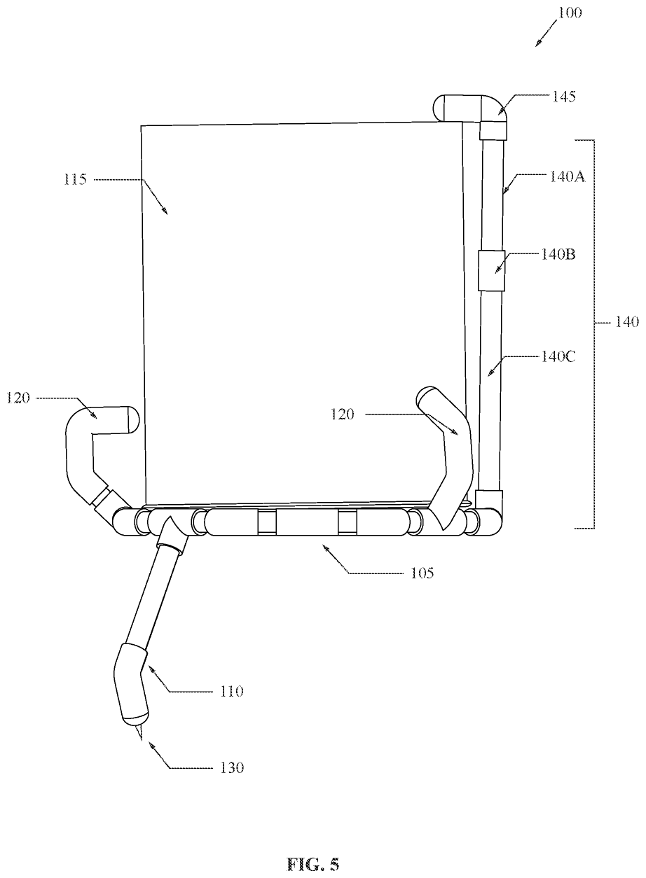

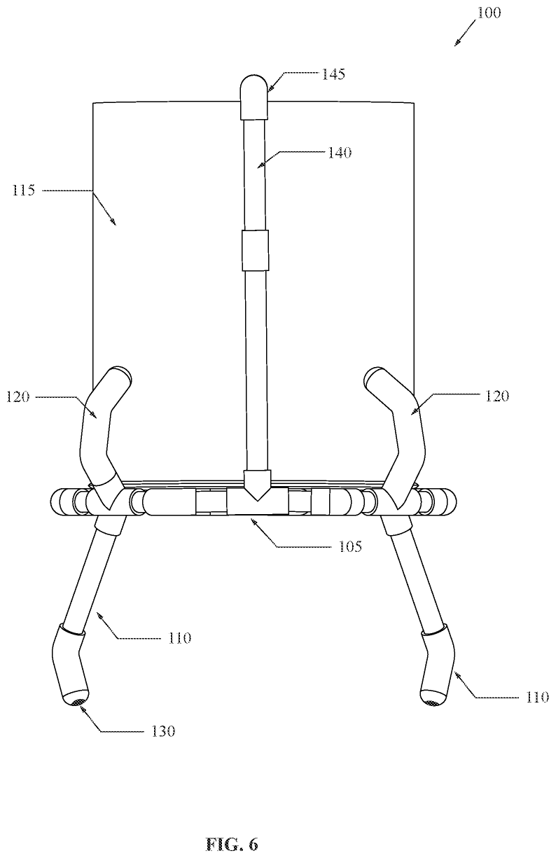

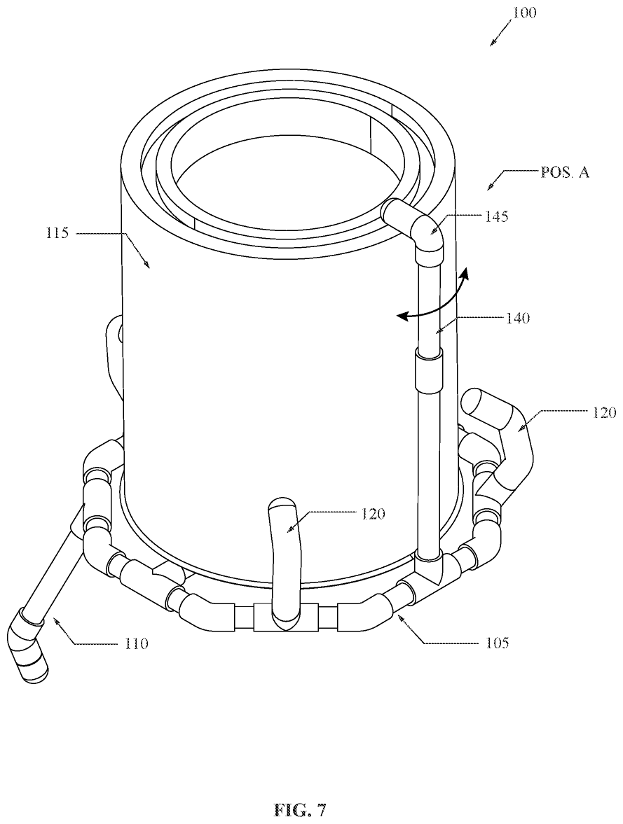

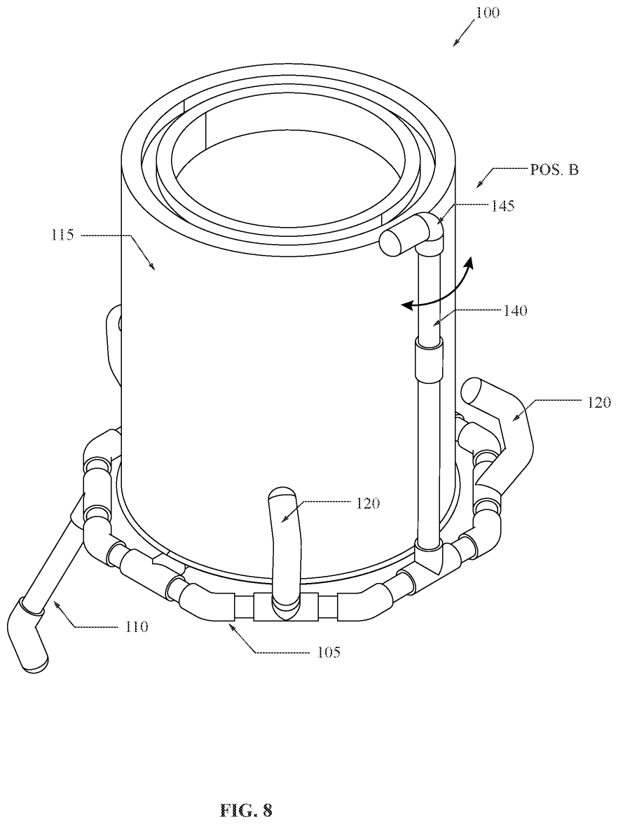

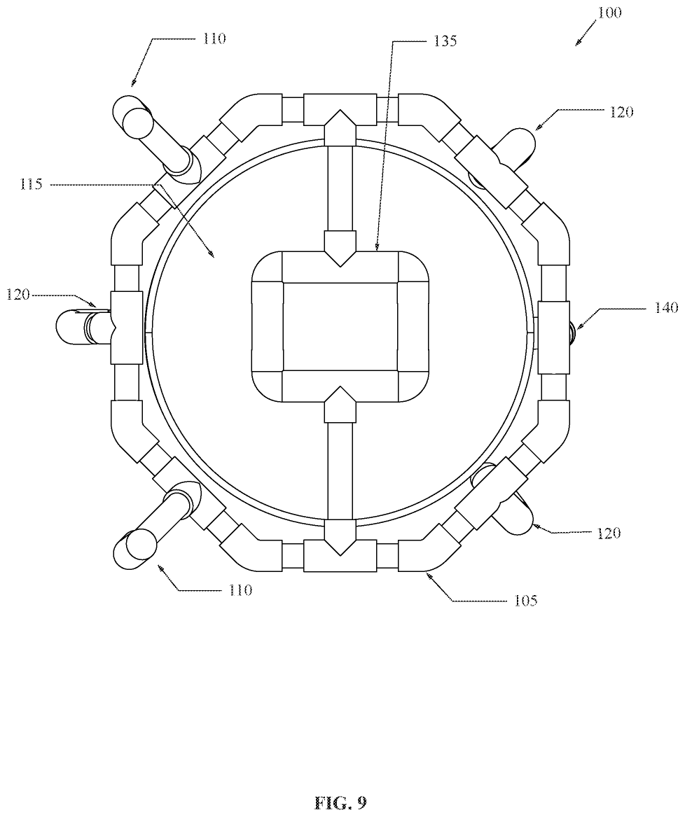

As shown in FIGS. 5, 6, 7, 8, and 9, the locking arm 140 may be configurable in height, interchangeable or adjustable by the user. During operation, in some embodiments, the user may rotate the entirety of the locking arm 140 relative to the base member 105. In alternative embodiments, only a component of the locking arm 140 may rotate. In yet another embodiment, no components rotate. In the rotation of the locking arm 140 or the tab 145, the locking arm 140 or the tab 145 is moved from a locked position POS.A to an unlocked position POS.B wherein the bucket 115 cannot be removed from contact with the base member 105. In some embodiments, the at least one locking arm 140 comprises a top member 140A, a joint 140B, and a lower member 140C. Wherein the lower member 140C is rigidly fixed to the base member 105 and the top member 140A is free to rotate within the joint 140B. In other embodiments, the top member 140A, the joint 140B, and the lower member 140C are rigid and only the tab 145 is free to rotate. In other embodiments, the retaining arm 120, the locking arm 140, and the legs 110 are positioned in equally spaced or opposing positions around the base member 105 to best secure the bucket 115 upon the base member 105. In some embodiments, the retaining arm 120, the locking arm 140, and the legs 110 are telescopic and variable in length as desired by the user.

Within the scope of the present invention, the bucket holder 100 may be sized to substantially match the shape and size of any commercially available bucket or cylindrical article, without limitation. For example, the bucket 115 for use with the bucket holder 100 may include a livestock bucket, an ice bucket, a paint pail, a 1-gallon paint can, a 2-gallon paint can, 5-gallon paint can, any sized bucket, a mop bucket, an industrial pail, a sand bucket, a barrel or a drum.

In embodiments of the bucket holder 100 is optimized for use with a 1-gallon paint can and the dimensions of the base member, the first arm, and the second arm may be sized to about 8 inches in height and about 7 inches in diameter to substantially fit the 1-gallon paint can securely within and upon the bucket holder 100. In embodiments of the bucket holder optimized for use with a 5-gallon bucket and the dimensions of the base member, the first arm and the second arm may be sized to about 15-16 inches in height and about 11-12 inches in diameter to substantially fit the 5-gallon bucket securely within and upon the bucket holder 100. In embodiments of the bucket holder optimized for use with a 5-gallon paint can and the dimensions of the base member, the first arm and the second arm may be sized to about 16-18 inches in height and about 10-12 inches in diameter to substantially fit the 5-gallon paint can securely within and upon the bucket holder 100.

In some embodiments, the bucket holder 100 may be assembled using at least one member of an attachment set between any component of the bucket holder 100 consisting of: a weld, a fastener, a pin, a tack, sandpaper, a knurled surface, an elastic member, an adhesive, a threaded protrusion, a chemical bonding process, a press-fit, a clamp, a magnet, a fabric member, a rivet, an anchor, and a spring. In some embodiments, the tab 145, the retaining arm 120, the locking arm 140 or the base member 105 may comprise at least one member of the attachment set.

In some embodiments, various components of the bucket holder 100 such as the base member 105, the at least two legs 110, the at least two retaining arms 120, and the at least one locking arm 140 are cylindrical. In such embodiments, the bucket holder 100 may be constructed of over-the-counter schedule 40 PVC, cast iron, copper, steel, or schedule 80 PVC piping and fitting. The bucket holder 100 may be constructed of any material by at least one of the following processes, by way of non-limiting example, including: a 3D printing process, sintering, casting, an injection moldings process, a CNC milling process, a rotational mold forming process, a blow molding process, a compression molding process and a vacuum forming process.

In some embodiments, the bucket holder 100 may require external texture to grip the hand of the user. In exemplary embodiments, the external texture further comprises at least one member of a texture set consisting of: indentations, sandpaper, extrusions, knurling, a rough surface, bumps, or any combination thereof.

In other embodiments, a further aide may be needed by the user to correlate the alignment and securing of the bucket 115 upon the bucket holder. In such embodiments, the bucket holder may comprise at least one member of an identification set consisting of: an alphanumeric identification, a human user's name, a symbolic shape, a company brand, a numeric identification number, a QR code, a barcode, and an RFID tag.

In reference to FIGS. 1 through 9, the present invention may include the following elements:

a bucket holder 100

a base member 105

a leg 110

a bucket 115

a retaining arm 120

an attachment member 130

a support member 135

a locking arm 140

a top member 140A

a joint 140B

a lower member 140C

a tab 145

a metal roof 150

a roof 155

a closed position POS. A

an opening position POS. B

As used in this application, the term “a” or “an” means “at least one” or “one or more.”

As used in this application, the term “about” or “approximately” refers to a range of values within plus or minus 10% of the specified number.

As used in this application, the term “substantially” means that the actual value is within about 10% of the actual desired value, particularly within about 5% of the actual desired value and especially within about 1% of the actual desired value of any variable, element or limit set forth herein.

All references throughout this application, for example patent documents including issued or granted patents or equivalents, patent application publications, and non-patent literature documents or other source material, are hereby incorporated by reference herein in their entireties, as though individually incorporated by reference, to the extent each reference is at least partially not inconsistent with the disclosure in the present application (for example, a reference that is partially inconsistent is incorporated by reference except for the partially inconsistent portion of the reference).

Unless otherwise defined, all technical terms used herein have the same meaning as commonly understood by one of ordinary skill in the art to which this disclosure belongs.

As used herein, the singular forms “a,” “an,” and “the” include plural references unless the context clearly dictates otherwise. Any reference to “or” herein is intended to encompass “and/or” unless otherwise stated.

As used herein, the term “about” refers to an amount that is near the stated amount by about 0%, 5%, or 10%, including increments therein.

Unless otherwise defined, all technical terms used herein have the same meaning as commonly understood by one of ordinary skill in the art to which this disclosure belongs.

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

Any element in a claim that does not explicitly state “means for” performing a specified function, or “step for” performing a specified function, is not to be interpreted as a “means” or “step” clause as specified in 35 U.S.C. § 112, 16. In particular, any use of “step of” in the claims is not intended to invoke the provision of 35 U.S.C. § 112, ¶6.

Persons of ordinary skill in the art may appreciate that numerous design configurations may be possible to enjoy the functional benefits of the inventive systems. Thus, given the wide variety of configurations and arrangements of embodiments of the present invention the scope of the invention is reflected by the breadth of the claims below rather than narrowed by the embodiments described above.

What is claimed is:

1. A bucket holder for securing a bucket upon a sloped surface, the bucket holder comprising:
a base member having a primary plane;
at least two legs extended outward and below the primary plane of base member;
at least two retaining arms extended outward and above the primary plane of base member;
at least one locking arm having a tab and extended outward and above the primary plane of base member; and
wherein a first mode of operation the bucket is placed upon the base member and secured by the tab of the at least one locking arm.

2. The bucket holder of claim 1, wherein the at least two legs of the bucket holder further comprise an attachment member.

3. The bucket holder of claim 1, further comprising:
a support member within the base member to reinforce the base member.

4. The bucket holder of claim 1, wherein the base member, the at least two legs, the at least two retaining arms and the at least one locking arm are cylindrical.

5. The bucket holder of claim 2, wherein the attachment member comprises at least one member of an attachment set comprising: a weld, a fastener, a pin, a tack, sandpaper, a knurled surface, an adhesive, a threaded protrusion, a chemical bonding process, a press fit, a clamp, a magnet, a fabric member, and a spring.

6. The bucket holder of claim 1, wherein the at least two legs of the bucket holder further comprise an attachment member.

7. The bucket holder of claim 1, wherein the base member includes a support member within.

8. The bucket holder of claim 1, wherein the base member further comprises a platform upon the base member.

9. The bucket holder of claim 1, wherein the at least one locking arm is substantially perpendicular to the base member.

10. The bucket holder of claim 1, wherein the at least one locking arm is rotatably adjoined to the base member.
